(19) United States
(12) Patent Application Publication
(10) Pub. No.: US 2026/0342855 A1
(43) Pub. Date: Oct. 29, 2026

(54) ENFORCEMENT OF DATA PRIVACY POLICIES WITH COMPLIANCE AUTOMATION FOR DATA SHARING

(71) Applicant: PAYPAL, INC., San Jose, CA (US)

(72) Inventors: Padmapriya Mohankumar, Chennai (IN); Vishal Kumar Singh, Howrah (IN); Ashraf Kamal, New Delhi (IN)

(21) Appl. No.: 19/191,651

(22) Filed: Apr. 28, 2025

(51) Int. Cl. H04L 9/40; G06F 21/62; H04L 41/16

(52) U.S. Cl. CPC H04L 63/20; G06F 21/6245; H04L 41/16

(57) ABSTRACT

There are provided systems and methods for enforcement of data privacy policies through smart contracts with compliance automation for data sharing. An online transaction processor or other service provider may provide computing services and products to users and entities. For data privacy policies, a service provider may provide a data privacy platform that encodes text from data privacy policies into machine-executable code for enforcement by automated integration agents. The agents may correspond to artificial intelligence automations created and deployed from different knowledge bases for types of data privacy matters and interests. Smart contracts may be generated and recorded for the encoded data privacy policies, where rules for different policies may be established as directed graphs for a graph-based compliance engine to execute. The automated agents may then monitor for smart contract enforcement and utilize the engine to enforce policies and reconcile conflicting policies.

### TECHNICAL FIELD

The present application generally relates to data acquisition through user interfaces (UIs) and data collection operations, and more particularly to selectively acquiring user data based on intelligently created rules for adaptive learning engines.

### BACKGROUND

Service providers may have large computing systems that provide numerous services through automated interfaces and interactions with different end users, such as customers, clients, internal users and teams, and the like. Users may interact with various applications, websites, and/or other digital platforms via computing devices, as well as exchange messages and content via text messaging, emails, push notifications, instant messaging, and other electronic communication channels. Use of such services typically requires providing and/or sharing private data and/or privacy protected data, such as personally identifiable data (PII), know your customer (KYC) data, financial data, and the like that may be privacy protected and/or desirable to remain private or not be shared. However, advertisers and other big data users may want to obtain personal and/or privacy protected data for advertising and business purposes. Further, fraudsters may attempt to compromise sensitive data to access and/or utilize such data for fraudulent purposes, such as to perform fraudulent electronic transaction processing or account takeover.

As such, laws, rules, and regulations may govern consent to sharing private data and privacy concerns of users. However, conventional data privacy and data sharing protections may not have sufficient mechanisms to enforce data usage rules, verify compliance in real-time, and ensure privacy-preserving transparency during disputes, which leads to inefficiencies, regulatory risks, and trust issues. Thus, it is desirable for service providers to implement an automated system to establish and manage data sharing agreements and compliance with data privacy policies in a faster and more efficient manner while enforcing reconciliation with those policies in a shared and distributed manner.

### BRIEF DESCRIPTION OF THE DRAWINGS

FIG. 1 is a block diagram of a networked system suitable for implementing the processes described herein, according to an embodiment;

FIG. 2 is an exemplary diagram of a system architecture and/or environment in which data privacy policies are managed using automated agents and smart contracts, according to an embodiment;

FIGS. 3A and 3B are exemplary diagrams of system architectures and/or environments where an automated agent may be assigned an encoded data privacy policy that is used to generate and manage a corresponding data privacy policy through a smart contract, according to various embodiments;

FIG. 4 is a flowchart for enforcement of data privacy policies through smart contracts with compliance automation for data sharing, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for enforcement of data privacy policies through smart contracts with compliance automation for data sharing. Systems suitable for practicing methods of the present disclosure are also provided.

To utilize the computing services of online service providers, such as electronic transaction processors that may provide merchants and customers with digital accounts for payment processing, users may be required to onboard with the service providers and proceed through data collection processes for user verification and the like. Users may correspond to individual customers or end users, as well as employees, owners, agents, etc., of merchants or other entities. These users may engage with computing platforms, applications, and websites of service providers that require users to provide personally identifiable data (PII), know your customer (KYC) data, privacy protected data, and other personal, financial, or private data that may be regulated for storage, use, and/or sharing by law, rule, regulations, or other requirement, whether organization/company specific or mandated based on region, field, type of data, etc. For example, personal or financial user data may be entered or uploaded during an account establishment or maintenance phase for a user account of a user, while processing transactions or engaging in other online interactions by users, and/or communicated to a service provider via an email, a text message, or the like when responding to customer service or other customer outreach.

To comply with data privacy protections, laws, rules, and regulations, the service provider may implement data privacy and security measures and may further request consent and authorization to utilize the user data (e.g., for internal marketing, advertising, statistics and/or data research, etc.), as well as store and retain this data. These requirements for data privacy and protection may be established in data privacy policies and rules of an organization, such as a company or other business that uses or manages data for users. The data policies may also be guided by user preferences and/or may be established for different user preferences, opt-ins or opt-outs to data storage and use, and other user settings. However, encoding of these policies into executable rules and policy “agents,” or automations, may be difficult to employ, manage and reconcile across many platforms, data ecosystems, and/or computing services to ensure compliance with privacy policies, These agents may correspond to computer programs, artificial intelligence (AI) models (e.g., machine learning (ML) models, neural network (NN) or other deep learning models, large language models (LLMs) or other generative AIs including those with language capabilities, etc.), and the like.

A service provider, which may provide services to users including electronic transaction processing (e.g., an online transaction processor, such as PayPal®), may allow merchants, users, and other entities to engage in online interactions, which may include use of computing services to process transactions, provide payments, and/or transfer funds between these users. The user may also interact with the service provider to establish an account and provide other information for the user to utilize the computing services of the service provider. Service providers may also or instead provide other computing services than those associated with electronic transaction processing, including social networking, microblogging, media sharing, messaging, news, entertainment, business, consumer platforms, etc. In order to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and the like.

The user may also be required to provide financial information, including payment card (e.g., credit/debit card) information, bank account information, gift card information, benefits/incentives, and/or financial investments, which may be used to process transactions for items. The account creation may also be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

Once the account of the user is established with the service provider, the user may utilize the account via one or more computing devices, such as a personal computer, tablet computer, mobile smart phone, or the like. The user may engage in one or more online or virtual interactions, such as browsing websites and data available with websites of merchants. In this regard, the transaction processor or other online service provider may offer and provide computing services through data processing of account and transaction data for electronic transaction processing, as well as other data processing services for other use of computing services on websites, applications, or other online portals of the merchant.

All of these interactions may generate and/or process data, which may be privacy protected by rule, law, policy, or regulation, and/or policy management and enforcement may be required. As such, the service provider may include privacy protected data, such as PII, financial data, health data, transaction data and/or histories, KYC data, and the like. Service providers may attempt to provide strong privacy protection through data privacy policies, which may identify and govern the service provider's rules, operations, and systems for compliance with laws, regulations, and company rules or objectives governing privacy protection. This may prevent data from being shared without consent, and privacy regulations, including the European Union's General Data Protection Regulation (GDPR) and the California Consumer Privacy Act (CCPA), may mandate organizations'requirements to establish and maintain compliance with these policies. To implement privacy protection and policy compliance, service providers may utilize a data privacy and sharing system, where compliance with data storage, use, and sharing may be enforced. However, managing data sharing agreements in compliance with privacy regulations, including GDPR, HIPAA, or CCPA, is a complex process that often involves manual oversight and is prone to disputes or errors.

In contrast to conventional systems that require such manual efforts and maintenance, a service provider, as described herein in one or more embodiments, may provide a privacy policy reconciliation and smart contract generation and enforcement framework for managing such privacy policies for requirements, permissions, and the like. This framework may manage and automate privacy regulation compliance in data-sharing agreements through cryptographic techniques, smart contracts, and contract enforcement and reconciliation to ensure real-time compliance with privacy regulations during data sharing. These smart contracts dynamically enforce rules, provide transparent audit trails via blockchain records and verification, and automate compliance, reducing disputes and enhancing trust.

In this regard, privacy-enforcing smart contracts may provide dynamic privacy rule encoding in smart contracts. A graph-based compliance engine may be used to convert complex regulations (e.g., GDPR, HIPAA, company privacy policies, customer preferences and opt-ins/opt-outs, etc.) into directed acyclic graphs (DAGs) or graph representations (e.g., data represented in a graph form, such as directed graphs that may be traversed from node to node along edges, as well as other graph-based and/or visual representations), enabling granular decomposition of rules into actionable smart contract logic. The engine may update smart contracts and/or a smart contract enforcement engine (e.g., through new smart contracts that may be written and/or stored on a blockchain or another distributed network, such as in one or more blockchain records or distributed records stored by the distributed computing devices or other nodes of the distributed network). This allows dynamically updating a compliance engine to have new and/or updated smart contracts with regulatory changes via live regulatory application programming interfaces (APIs) that may publish, provide, or make available the policies and/or rules, regulations, or laws for policy creation. As such, the engine may ensure ongoing compliance with data privacy requirements.

The service provider may further provide fine-grained access control using recursive zero-knowledge proofs (rZKP). With a recursive zero-knowledge proof, a proof may be used to attest to the validity of another proof, which validates another proof, which proceeds in a continuous manner over the set of zero knowledge proofs required for validation. This allows for proving the validity of something, such as a statement or with cryptography, encryption, and blockchain, the validity of transactions, blocks, and/or encryption, without revealing additional information regarding that statement or other thing to validated. This may be used to determine whether an off-chain computation for verification has been performed correctly and validated. The system may use recursive ZKPs, enabling composability of multiple proof verifications in a single transaction (e.g., identity, usage scope, and retention rules) in real-time for policy enforcement of privacy requirements from smart contracts.

An automated enforcement of usage constraints with perturbation budget management may also be provided by the privacy compliance system, For example, by embedding perturbation “budgets” into the smart contract or variance from compliance requirements with data privacy requirements for data access and sharing, the system may ensure that cumulative noise added to data queries for data retrieval and/or sharing remains compliant with data privacy over repeated access to data while maximizing data utility. Further, the system may provide blockchain-based transparency and enhanced auditability using smart contracts that may be utilized and enforced during data sharing requests and events, and allows recordation or auditability of data sharing for privacy compliance through the smart contracts persisted on and used from a blockchain. Although blockchains are discussed herein as the distributed ledger and network on which the smart contracts may be persisted and against which the automated agents may check for policy enforcement from smart contract recordation, it is understood that other types of distributed networks may provide the same or similar functionality, and, as such, smart contracts may otherwise be persisted on a ledger for such networks that provides data privacy policy enforcement.

For example, to enforce contracts in a compliance engine without a blockchain, distributed policy graph replication may be used. With distributed policy graph replication, the compliance engine may have, for each DAG of compliance rules, there may reside a replicated policy graph store. Engines exchange compact graph deltas over a peer-to-peer gossip channel and built-in merge rules in the graph structure guarantee that concurrent updates resolve deterministically, so every node eventually holds an identical policy graph. A cryptographic fingerprint on each graph snapshot lets any two engines confirm they enforce the same rule set without querying a central registry. Enforcement points (EPs) with an immutable audit stream may also be used, where EPs are deployed at every data-access boundary. An EP intercepts each request, runs the DAG interpreter, then outputs a signed audit record into a tamper-evident append-only stream. Each record includes its hash-chaining to the previous entry, a precise timestamp, and the EP's digital signature. Systems can replay this stream end-to-end to reconstruct every rule decision and its context, ensuring a non-repudiable compliance trail

Further with “no-blockchain” based smart contract enforcement, a hash-chained audit ledger in a central store may maintain a centralized “compliance ledger” table where each policy invocation and outcome is a new row. Every entry contains a hash over the request payload, decision outcome, and policy version, the preceding entry's hash reference, forming a continuous chain, and the Compliance Engine's signature. Because each row cryptographically links to its predecessor, any tampering breaks the chain. Periodically, the current chain head (i.e., a root hash) may be published to an external time-stamping service. Ledger dumps can be fetched to verify chain integrity and timestamps, which may attain the same tamper-evident guarantees as an immutable ledger. Immutable audit trails may leverage cryptographically signed logs (e.g., Merkle trees or hash chains) to ensure that all compliance actions and policy updates are tamper-evident and easily auditable by external parties.

The system may provide immutable logging of privacy policies and enforcements with privacy-enhancing layer-two rollups of smart contract enforcement computations. For example, smart contracts may allow the system to integrate privacy-preserving rollups (e.g., through an engine for scalability, such as zkPorter, which may perform computations for blockchain validation and recordation) to log data-sharing transactions efficiently while concealing sensitive details from parties and blockchain persistence. This enables both scalability and compliance with jurisdictional privacy requirements. An attribute-based metadata encryption with forward-secure keys may be provided for data encryption of sensitive and/or privacy protected data during data sharing and/or recordation of smart contract enforcement and/or compliance. For example, the system may employ forward-secure attribute-based encryption (FS-ABE) for on-chain metadata, allowing time-bound encryption keys to adapt dynamically. This ensures that metadata remains accessible only during valid sharing windows and securely expires afterward.

A decentralized dispute resolution may integrate Hybrid Functional Encryption, where computations (e.g., determining compliance breaches) may be securely performed on predefined functions, which may ensure that sensitive data remains encrypted while enabling limited-purpose evaluations. The system may further perform automated penalty enforcement and advanced compliance monitoring. For penalty enforcement, smart contracts may use a reinforcement learning-augmented game theory model that predicts optimal penalty structures based on behavioral data. This mode may enforce compliance dynamically by adapting penalties in response to patterns of non-compliance across organizations. Real-time compliance monitoring may use an adaptive multi-agent system where a network of adaptive reinforcement-learning agents may be embedded in the blockchain to periodically and/or continually monitor data-sharing transactions. Each agent may specialize in a specific compliance domain (e.g., retention policies, usage limits, data domains, etc.) and may collaborate securely through homomorphic encryption to detect anomalies or breaches in data security, privacy, and/or data sharing events and requirements. Proactive regulatory reporting may be provided through graph neural networks (GNNs), where smart contracts may leverage GNNs trained on compliance transaction graphs to automatically generate real-time, regulation-specific compliance reports. These models analyze the interconnectedness of transactions to flag potential risks and preemptively alert privacy stakeholders, such as users corresponding to the data, entities sharing the data, privacy compliance users or entities, and the like.

As such, the smart contracts and privacy policy AI agents may be used for management of data sharing during and/or associated with financial transactions, such as by automating compliance with regulations like CCPA in data exchanges between financial institutions and analytics platforms. HIPAA-compliant data sharing may further be improved using this system for privacy policy smart contract usage by ensuring HIPAA-compliant patient data sharing across hospitals and researchers remains privacy compliant and by enforcing usage constraints and penalties automatically. Cross-border data transfers may require managing GDPR compliance for multinational corporations, such as when sharing data between jurisdictions with varying privacy laws, which may utilize smart contracts as provided and managed by the privacy protection system for privacy enforcement described herein. Additionally, data marketplaces may utilize this system for improved data privacy through smart contracts, enabling privacy-compliant data sharing and monetization on blockchain-based marketplaces while preventing misuse. This may reduce repetitive data entry for privacy protected data and manual oversight of privacy controls, thereby simplifying and creating more efficient and secure data privacy protection systems. Further, while existing platforms often struggle with scalability, particularly when handling many different types of privacy protected data, the system herein may provide improve scalability through smart contracts and blockchain validation and recordation of data-sharing transactions while preserving privacy protected data from being shared on-chain or with unauthorized parties.

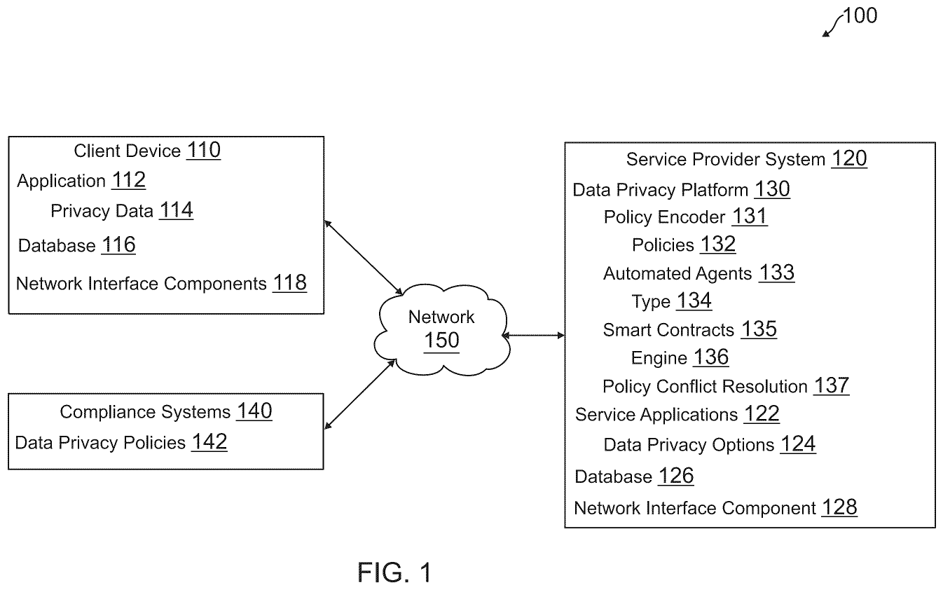

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110, a service provider system 120, and compliance systems 140 in communication over a network 150. Client device 110 may be utilized by a user to receive and transmit communications over network 150, where service provider system 120 may provide various data, operations, and other functions over network 150 to provide services to users, entities, and their corresponding computing devices. In this regard, client device 110 may be used to provide privacy protected data that may be used and/or stored by service provider system 120, such as when utilizing a computing service or digital product of service provider system 120. Service provider system 120 may encode the received data from client device 110 consistent with data privacy policies associated with compliance systems 140, which may be enforced through automated agents and smart contracts, as discussed herein.

Client device 110, service provider system 120, and compliance systems 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device that may utilize appropriate hardware and software configured for wired and/or wireless communication with service provider system 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS ®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

In some embodiments, application 112 may correspond to one or more processes to execute software modules and associated components of client device 110 to provide features, services, and other operations by a customer or other user, including users of entities over network 150 (e.g., employees, owners, or the like that may work for or be part of a business, which may include merchants and other customer entities of service provider system 120). Application 112 may be used to engage with computing services and products of service provider system 120. In this regard, application 112 may provide privacy data 114 during a use of a computing service and/or digital product of service provider system 120, such as one for electronic transaction processing from an online transaction processor corresponding to service provider system 120. In this regard, privacy data 114 may be provided for onboarding, user identification and/or authentication/verification, product/service usage, and the like with service provider system 120, for example, when opening or maintaining an account, processing a payment and/or using electronic transaction processing services, and other computing services provided through one or more of service applications 122 and corresponding user interfaces.

Application 112 may be utilized by a user on client device 110 to access websites and/or application data and display user interfaces, such as browser or application interfaces that may be used for interaction with and/or navigation between webpages and/or application interfaces and other data from service applications 122. In some examples, application 112 may be used to provide transaction processing for products, such as through a user interface enabling the user to enter and/or view the products that the user associated with client device 110 wishes to purchase. This may be based on transactions generated by application 112 using one or more merchant websites and/or marketplaces, where use of accounts, computing services, and other products may require data submission via the user interface(s) of privacy data 114, which can include user data, financial data, or other data that may be privacy protected and require implementation of data privacy protections based on data privacy policies and corresponding rules or other laws, regulations, and/or obligations.

For example, to process transactions, application 112 may utilize user financial information, such as credit card data, bank account data, or other funding source data, as a payment instrument when providing payment information. Additionally, application 112 may utilize a digital wallet associated with an account with service provider system 120 as the payment instrument, for example, through accessing a digital wallet or account of a user through entry of identification and authentication credentials and/or by providing a data token that allows for processing using the account. Application 112 may also be used to receive a receipt or other information based on transaction processing. Different services may also be provided via application 112, including social networking, media posting or sharing, microblogging, data browsing and searching, online shopping, and other services available through service provider system 120. Thus, application 112 may also correspond to different service applications and the like, and the aforementioned data processed by application 112 with service provider system 120 may include privacy data 114.

When engaging with service provider system 120 and/or another website, application, or platform that may utilize the computing services of service provider system 120 (e.g., for accounts, electronic transaction processing, risk, etc.), service provider system 120 may require acquisition of privacy data 114, such as financial data for payment processing, underwriting, regulatory compliance, risk or fraud including anti-money laundering, and the like. Service provider system 120 may implement data privacy protections using automated agents and smart contracts, as discussed herein. Application 112 may further be used, via one or more user interfaces, to specify, opt-in to, and/or opt-out of certain data privacy protections, which may be used when generating user-specific data privacy policies. These data privacy policies may provide more granularly controlled access to privacy data 114 than general data privacy policies that may be encoded and enforced by service provider system 120. This allows the user, via the user interface(s), to control access to privacy data 114 through different controls on data privacy with service provider system 120. As such, when enforcing data privacy protections, service provider system 120 may utilize automated agents and smart contracts specifically tailored for user privacy policies in a more efficient and optimized manner.

Application 112 may correspond to a general browser application and/or general, native, or local software application including mobile applications that may be configured to retrieve, present, and communicate information over the Internet (e.g., utilize resources on the World Wide Web) or a private network. For example, application 112 may provide a web browser, which may send and receive information over network 150, including retrieving website information (e.g., a website for an email provider or other messaging service), presenting the website information to the user, and/or communicating information to the website. Application 112 may include a dedicated application provided by service provider system 120 that transmits privacy data 114 to or permits access of privacy data 114 by service provider system 120. Privacy data 114 may be associated with digital payment accounts, account information, user financial information, and/or transaction histories, which may be associated with electronic transaction processing services provided by service provider system 120.

Client device 110 may further include or have access to database 116, which may correspond to different types of data storage and components including cloud computing storage nodes, remote data stores and database systems, distributed database systems over network 150, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 120.

Client device 110 includes at least one network interface component 118 adapted to communicate with service provider system 120, compliance systems 140, and/or other devices and servers over network 150. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 may be maintained, for example, by an online service provider, which may provide computing services and operations via one or more digital platforms, applications, websites, and the like. Service provider system 120 may provide computing services to various entities, which may require use of, and/or generate from use of computing services, privacy protected data including privacy data 114 from client device 110. The privacy protected data may be required to be handled, shared, stored, and/or deleted based on policies for data privacy requirements and data privacy protections provided to consumers, customers, and other users of service provider system 120, such as those users that engage in use of the computing services and digital products of service provider system 120. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes and/or is associated with a data privacy platform 130, service applications 122, a database 126, and a network interface component 128, implementations of which are discussed further below. Data privacy platform 130 and service applications 122 may correspond to executable processes, procedures, and/or applications with associated hardware. In other embodiments, service provider system 120 may include additional or different modules having specialized hardware and/or software as required.

Data privacy platform 130 may correspond to one or more processes to execute modules and associated specialized hardware of service provider system 120 to provide data privacy policy monitoring and enforcement through smart contracts with compliance automation for data sharing using automated agents or other intelligent automations. In this regard, data privacy platform 130 may correspond to specialized hardware and/or software used by a user associated with client device 110 to provide operations for encoding data privacy policies into machine-readable and/or executable formats, assigning policies to automated agents, encoding the policies into smart contracts, and deploying the agents with the smart contracts in a monitoring and enforcement layer of data privacy platform 130 for enforcement with data requests and reconciliation with different competing policies for data privacy. In this regard, data privacy policies may contain rules, in text or other natural language form, that an entity may be required to enforce to protect or prevent certain data from being revealed, shared, or misappropriated, or otherwise revealed to others in an unauthorized manner. As such, a policy encoder 131 may perform encoding operations to convert natural language text, text-based rules, commands, objectives, or the like from policies 132 that may be in initially written or entered in alphanumeric characters or the like to machine-readable or machine-executable code or format that may be capable of being read, executed, and/or performed by one or more automated bots, scripts, programs, or applications.

For example, policy encoder 131 may be used to specifically configure policies 132 that may be written in plain text and/or natural language into computer code that may be executable by an automation, such as a computer bot, script, or program. As such, policy encoder 131 may include a machine encoder configured to generate machine-readable and/or machine-executable computer code. Policies 132 may also be provided in encoded format by a creator of policies 132, such as compliance systems 140, which may provide data privacy policies 142 for encoding or may encode data privacy policies 142 and send for management and enforcement by data privacy platform 130. Policies 132 may also include user-specific policies and/or policies generated for one or more users based on their configurations, settings, preferences, opt-ins/opt-outs, and the like for data privacy controls and protections. In some embodiments, the encoded format may include numeric vectors and the like, which may be used to assess privacy controls, requirements, and/or protections for data based on an identity of a requester of the data, a purpose for which the data is requested, an endpoint where the data will be sent or that will access and utilize the data, and the like.

Automated agents 133 may correspond to AI bots, scripts, programs, applications, or other intelligent computer operation that may generate smart contracts for encoded policies once assigned and enforce those smart contracts when privacy protected data is requested. Automated agents 133 may also provide for policy reconciliation and/or resolution of disputes between different policies that may have different or conflicting rules regarding a data privacy protection (e.g., whether a user or data is entitled to protection, what the protection is, who is authorized to access/use the data, etc.) and/or specific privacy protected data (e.g., a particular data record or group of records and who may access, share, etc.). In this regard, automated agents 133 each include a type, such as a “user agent,” “policy agent,” “regulation compliance agent,” etc. Each of automated agents 133 may be categorized by their corresponding one of types 134, where types 134 may each include a purpose and structure used to create or configure automated agents 133. Thus, types 134 may correspond to characteristics or features of a data privacy protection provided to privacy protected data by each of automated agents 133.

Automated agents 133 may include one or more AI or ML models, NNs, conversational AIs, or the like. AI models may have trained layers based on training data and selected features or data variables configured for data collection process inferencing, such as policy enforcement through data matching and/or data request processing. For example, ML features or variables may correspond to individual pieces, properties, characteristics, or other inputs for an ML model and may be used to cause an output by that ML model once the ML model has been trained using data for those features from training data. AI models may be used for computation and calculation of model scores based on layers, nodes, branches, clusters, rules, and the like that are trained and optimized. As such, ML models may be trained to provide a predictive output, such as a score, likelihood, probability, or decision, associated with a particular prediction, classification, or categorization.

AI models may include DNNs, MLs, LLMs, generative AIs, or other AI models trained using training data having data records that have columns or other data representations and stored data values (e.g., in rows for the data tables having feature columns) for the features. When building AI models, training data may be used to generate one or more classifiers and provide recommendations, predictions, or other outputs based on those classifications and an ML or NN model algorithm and architecture. The algorithm and architecture for the AI models may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different output value based on the input values. The values generated by the hidden layer nodes may be used by the output layer node(s) to produce one or more output values for ML models that attempt to classify and/or categorize the input feature data and/or data records. Thus, when the AI models are used to perform a predictive analysis and output, the input data may provide a corresponding output based on the trained classifications.

Layers, branches, clusters, or the like of the AI models may be trained by using training data associated with data records of interest, such as data privacy policies, which may be encoded, and requests for privacy protected data, conflicts between data privacy policies and which policies override others or are controlling in such disputes, breaches of privacy protected data, and the like. By providing training data, the nodes in the hidden layer may be trained (adjusted) such that an optimal output (e.g., a classification) is produced in the output layer based on the training data. By continuously providing different sets of training data and/or penalizing the AI models when the outputs are incorrect, the AI models (and specifically, the representations of the nodes in the hidden layer) may be trained (adjusted) to improve its performance in data classifications and predictions. Adjusting of the AI models may include adjusting the weights associated with each node in the hidden layer.

Smart contracts 135 may correspond to self-executing agreements that may be stored on a blockchain, a distributed ledger for a distributed network, or other mechanism of permanence and immutability that enables smart contracts 135 to be read and executed when conditions are met or smart contract validity time periods expire. In this regard, smart contracts 135 may be generated from encodings of policies 132 by policy encoder 131, which may cause smart contracts 135 to have conditions for data privacy policy enforcement, such as encoded rules for data privacy protections and requirements. As such, when a condition for data privacy is met, such as certain privacy protected data is requested, smart contracts 135 may be executed to determine a corresponding outcome. Smart contracts 135 may be generated and enforced through an engine 136, which may use automated agents 133 for monitoring of smart contracts 135 and enforcement, as well as resolution between conflicting ones of smart contracts 135. Engine 136 may correspond to an intelligent automation to perform smart contract generation and recordation on a blockchain, such as by distributing to the computers or other nodes of the blockchain for storage in a decentralized and immutable ledger, as well as enforcement through smart contract execution when conditions are detected by automated agents 133. Engine 136 may function similarly with other types of distributed networks and corresponding ledgers or public and/or distributed data storage, recordation, and validation mechanisms.

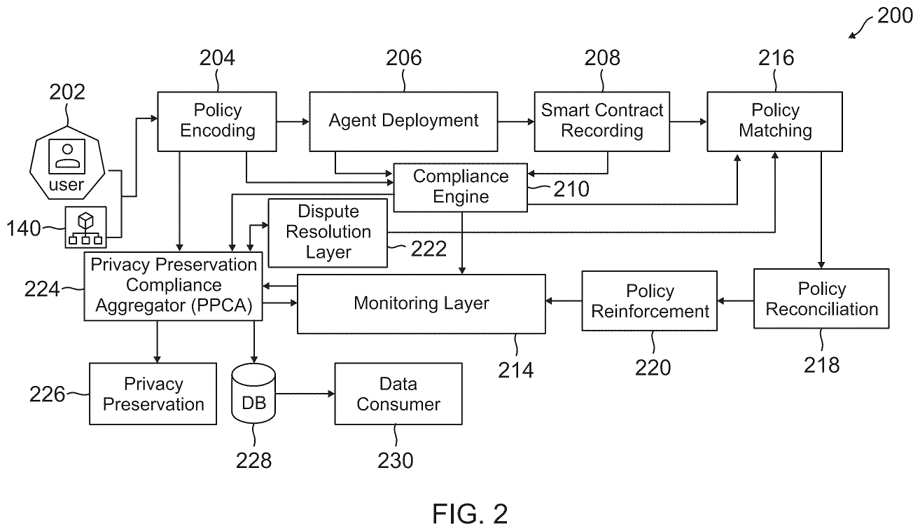

Policy conflict resolution 137 may correspond to a process by which two or more policies having conflicting rules for data privacy, such as who can access and/or share the data, with whom the data can be shared, how long to retain or when to delete, etc., may be resolved. Policy conflict resolution 137 may include determining the overriding or controlling policies based on importance, law, requirement, requester, and the like, as well as which policy was in effect first, which policy may be grandfathered in or acceptable even if conflicting with more recent policies, and the like. Policy conflict resolution 137 may be provided on a policy layer of data privacy platform 130, which may have multiple different layers for the different steps and components associated with data privacy. For example, an encoding layer or encoder layer may perform encoding using policy encoder 131, an agent layer may perform selection and/or assignment of automated agents 133 to different policies, a smart contract layer associated with smart contracts 135 may perform smart contract generation for encoded rules and/or policies, and a policy enforcement layer and/or conflict resolution layer may perform policy enforcement and/or conflict resolution to enforce policies using the automations and resolve conflicts between different policies, respectively. The operations for automated enforcement of data privacy policies through smart contracts are discussed in further detail with regard to FIGS. 2-4 below.

Service applications 122 may correspond to one or more processes to execute modules and associated specialized hardware of service provider system 120 to process a transaction and/or provide other computing services to users. For example, service applications 122 may include a transaction processing application used to process payments and other services to one or more users, merchants, and/or other entities for transactions, where users may provide data for use of the transaction processing application or other services applications that may be managed for data privacy using data privacy options 124. Data privacy options 124 may be provided through a UI with selectable options, menus, fields for data entry, and other elements configured and provided to data privacy policy preferences, opt-ins/opt-outs, and other selections. Such selections may be used to generate user-specific data privacy policies, which may require enforcement by data privacy platform 130.

An account may be used to send and receive payments, including those payments that may be enabled on digital platforms and/or in-person at POS devices and other payment terminals. A payment account may be accessed and/or used through a browser application and/or dedicated payment application executed by client device 110, such a payment and/or digital wallet application. The transaction processing application may process payments and may provide transaction histories to client device 110 and/or another user's device or account for transaction authorization, approval, or denial of the transaction for release of the funds, including transfer of the funds between accounts. Such accounts may be associated with privacy protected data, which may be managed and controlled by data privacy options 124. Further, service applications 122 may provide different computing services, including social networking, microblogging, media sharing, messaging, business and consumer platforms, etc. These computing services may be used by users or entities, where data collection and service usage may include use of privacy protected data that may be managed in accordance with data privacy options 124.

Service applications 122 further may provide additional features to service provider system 120 for internal and/or external applications, websites, systems, processors, and the like. For example, service applications 122 may include security applications for implementing server-side security features, programmatic client applications for interfacing with appropriate application programming interfaces (APIs) over network 150, or other types of applications. Service applications 122 may contain software programs, executable by a processor, including one or more GUIs and the like, configured to provide an interface to the user when accessing service provider system 120, where the user or other users may interact with the GUI to view and communicate information more easily. Service applications 122 may include additional connection and/or communication applications, which may be utilized to communicate information to over network 150.

Additionally, service provider system 120 includes or may access database 126. Database 126 may store various identifiers associated with client device 110 and/or other devices and/or servers that may engage and/or interact with accounts, computing services, and/or data privacy options 124. Database 126 may also store account data, including payment instruments, financial information, account balances, and authentication credentials, as well as transaction processing histories and data for processed transactions. As such, database 126 may include privacy protected data, and data privacy platform 130 may provide monitoring and enforcement of privacy protections to such data. Although database 126 is shown as residing on service provider system 120 as a database, in other embodiments, other types of data storage and components may be used including cloud computing storage nodes, remote data stores and database systems, distributed database systems over network 150 and/or of a computing system associated with service provider system 120, and the like.

Service provider system 120 may include at least one network interface component 128 adapted to communicate with client device 110, compliance systems 140, and/or other devices and servers over network 150. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Compliance systems 140 may include devices, servers, and other computing systems of regulatory or governing entities, which may be maintained to provide a set of regulatory (e.g., laws, rules, and regulations) requirements and/or guidance for data privacy and data maintenance of privacy protected data, including handling, storage, maintenance, and/or deletion by different online service providers and data storages. In this regard, compliance systems 140 may include and provide data that may be used to determine requirements for data privacy protections, including data privacy policies 142 by organizations, governments, regulatory bodies, agencies, and the like, where the policies may include privacy protection rules and other data privacy rules that grant the data privacy protections to customers and other users of online service providers. Compliance systems 140 may be used to determine data privacy policies 142 and corresponding rules for use with smart contract encoding and enforcement through automated agents 133, where the individual rules, or policies in part or in whole, may be encoded by compliance systems 140 or service provider system 120, as discussed herein.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

FIG. 2 is an exemplary diagram 200 of a system architecture and/or environment in which data privacy policies are managed using automated agents and smart contracts, according to an embodiment. Diagram 200 includes components of service provider system 120 that may be utilized for data privacy policy enforcement using automated agents and smart contracts, as discussed in reference to system 100 of FIG. 1. In this regard, diagram 200 includes a more granular representation of data privacy platform 130 and its corresponding interactions and data processing flows during data privacy policy encoding, dispute resolution, and enforcement.

In diagram 200, data privacy platform 130 of service provider system 120 may receive and/or collect data privacy policies from a user 202 of client device 110 and/or compliance system 140, discussed in system 100. As such, the data private policies may correspond to policies 132 or data privacy policies 142 in system 100 set or established by a governing body, but may also correspond to those from users that may configure their own preferences and/or opt-in/opt-outs to options for data privacy policies 142 and/or other ones of policies 132 that may have user configurable options or selections (e.g., how long data may be stored, what data may be shared with other third parties or internal systems for use, advertisement, personalization, etc.). A policy encoding process 204 may then perform an encoding of the policies from natural language, text, or other input format to a machine-readable and/or machine-executable format and/or computer code, such as numeric vectors, that may be executed by intelligent automated agents, such as AI models that may be executed or utilized by corresponding bots, scripts, programs, etc., when providing the automated agents. In some embodiments, encoding may be performed elsewhere, computer code may be provided as input, and policy encoding process 204 may receive the input computer code for data privacy policies and/or convert from one computer code format to another for handling.

Policy encoding process 204 may receive and/or collect policies for policy and rule encoding generation. A policy data collection layer may utilize web, mobile, and other applications to collect data from different sources regarding users, merchants, and/or other entities that may provide privacy protected data or policies to manage such data, including data to verify identities, financial data, business information, or the like, authenticate users, authorize users or entities for extension of services or products (e.g., underwriting), and the like. Data may be stored in customer profiles, which may be made available based on data privacy policies. Policies may be established by a service provider that offers products and services to users and/or corresponding entities (e.g., merchants, businesses, etc.), and may correspond to policies set for collecting and managing data. For example, policies may be associated with data requirements of computing services and/or products for their eligibility and/or provision including user authorization, verification, etc. Policies may be associated with a risk data requirement provider, a compliance data requirement provider, and/or a verification provider, such as risk and/or compliance policies, user verification policies, and the like. A policy aggregation layer may collect the policies in text for other processable form, including any directed graphs or flowcharts, and may provide the abstract requirements for the policies to policy encoding process 204 for processing and encoding.

Policy encoding process 204 may generate encodings of policies 132 by converting those requirements in text or other form to computer code, for example, using an AI engine (e.g., a natural language processor (NLP), LLM, and/or other language processor). The layer for policy encoding 204 may include Forward-Secure Public-Key Encryption (FS-PKE), where Elliptic Curve Diffie-Hellman (ECDH) may be used for secure key exchange and time-bounded encryption keys may enforce access expiration. Metadata for encoded policies may also be generated using FS-PKE for encryption and security, and an encryption key rotation may ensure keys expire dynamically. The attributes of the metadata may be cryptographically embedded in the encoded data.

The output code from an NLP and/or language model (e.g., LLM or generative AI) may be provided to an agent deployment process 206, which may assign and/or determine one of automated agents 133 to enforce the corresponding policy. Agents may be categorized by their purpose, structure, and type, such as ‘User agent’, ‘Policy agent’, ‘Privacy agent’, ‘Regulation compliance agent’, and ‘Privacy policy agent.’ Agent deployment process 206 may use a framework that takes input from an agent knowledge base and forms integration agents by combining individual agent characteristics for the policies to be enforced. Agents are deployed on behalf of stakeholders for the policies and may be matched to policies 132 once policies 132 are encoded. However, agents may also be associated with a server or other distributed network outside of blockchain-based networks and agents. For example, agents may be utilized with other networks having multiple connected nodes that manage data processing, storage, communication, and the like.

After agent deployment process 206 for automated agents that read and manage smart contracts associated with a blockchain or other distributed network, a smart contract recording process 208 may be performed where smart contracts 135 are generated, or existing ones that have yet to be distributed and recorded to a blockchain are updated, with the encoded policies. Smart contract recording process 208 may include adding the encoded rules and/or policies to smart contracts 135 that may be recorded to the corresponding blockchain for the selected protocol, and then distributing smart contracts 135 over or to the nodes of the blockchain's distributed ledger for recordation. This creates an immutable and public ledger that may be audited and verified. A compliance engine 210 may generate and/or enforce smart contracts 135, and therefore may receive and/or record smart contracts 135 once the encoded rules and/or policies are set with smart contracts 135. Monitoring and/or enforcement may occur through a monitoring layer 214 using the agents that have been deployed, as well as recorded smart contracts on the blockchain for privacy policy enforcement.

In this regard, the architecture of data privacy platform 130 in diagram 200 may include monitoring layer 214 that may provide real-time compliance monitoring to continuously oversee system behavior, data flows, and user interactions to ensure adherence to regulatory, policy, or ethical standards in real-time. Monitoring layer 214 verifies data usage in real-time and aggregates compliance data without revealing raw records. The components of this layer may include monitoring data ingestion to ensure only compliant data is ingested and redact or reject sensitive or non-permitted data types in real-time. Model behavior monitoring of AI/ML outputs to ensure fairness, non-discrimination, and explainability. This may detect potential drifts or bias inferences violating compliance standards. A rule-based engine may encode legal/regulatory rules (e.g., GDPR, HIPAA) to automatically flags or blocks actions violating these rules. An audit logging system may log all decisions, interventions, and data access. This supports traceability and post-hoc analysis for audits. An alert and escalation system may send real-time alerts when anomalies or violations occur, as well as trigger automated containment measures. Further, real-time dashboards may provide users with information that may visualize compliance posture across systems, as well as offer drill-down capabilities for investigation.

Automated penalty enforcement via game theory may also be provided. The non-compliance or risky behaviors are penalized automatically using strategic decision models to incentivize good behavior and deter violations. Automate penalty enforcement may be performed via two steps. First with risk-based Security Scoring (RBS-SMART), compliance scores may be dynamically assigned, and stake-weighted security deposits may enforce penalties on non-compliant parties. With RBS-SMART, actors may be users or devices and the risk-based scoring engine may Continuously score each actor based on behaviors, security events, policy violations, and the like. A game-theoretic decision layer may model actor choices as strategic games (e.g., Nash Equilibrium, Stackelberg Games) and identify utility-maximizing actions under different penalty/reward structures.

Further, the automated penalty enforcement layer may apply real-time penalties (e.g., access revocation, additional verification). Rewards may include trust restoration, increased access, and reduced monitoring. A monitoring and feedback loop may feed behavioral changes back to the scoring engine to update strategy models. With stake-weighted security deposits, a stake registry layer may be provided where actors deposit a stake (e.g., a token, credit, trust points) into the system. The stake amount may be weighted by access level, sensitivity of role, etc. Thereafter, a real-time behavior monitor may detect violations, anomalies, or non-compliant actions, calculate severity of infraction, and use a game-theoretic penalty engine to compute expected utility for compliant vs non-compliant behavior. Automated penalties may be automatically applied from the stake deposit based on the severity of violation, the actor's past behavior, and the probability of detection for strategic deterrence. An incentive/reward model may tie trust score and access permissions to good standing with the system.

Smart contracts 135 are matched to corresponding integrations agents from automated agents 133 based on types 134 of the agents and corresponding rules or details of the data privacy policies during a policy matching process 216. After a policy matching process 216 occurs, a policy reconciliation process 218 may reconcile and validate any conflicting policies, such as by causing the controlling rule or policy to be used and/or validating a smart contract to override a previous rule and/or policy in favor of the controlling, governing, or overriding rule and/or policy. A policy reinforcement process 220 may then validate new smart contracts to reenforce and/or override existing smart contracts for policies that may have conflicts with the policies other smart contracts. The conflicts may be managed through a dispute resolution layer 222 that may utilize one or more automated agents to monitor different policies and determine if policies have conflicting rules for the same data privacy requirements or protections.

When data is requested, a privacy preservation compliance aggregator (PPCA) 224 may provide policy enforcement through the automated agents and corresponding smart contracts. Automated agents may monitor incoming data requests for privacy protected data with PPCA 224 to determine if a data request impacts or is controlled by the data privacy protection and/or requirement of the rules of a corresponding smart contract that the agents enforce. For example, automated agents may determine if the conditions for data privacy protections or requirements of the rules of a smart contract are triggered at PPCA 224 and what the resulting protection or requirement is for the data requested. A privacy preservation process 226 may then determine an action to take with privacy protected data from database 228, which may be shared with a data consumer 230, hidden or not shared with data consumer 230, or have another action taken with regard to sharing, providing, or transmitting the data that is privacy protected to data consumer 230 (e.g., redacting certain data, reporting to data consumer 230, etc.).

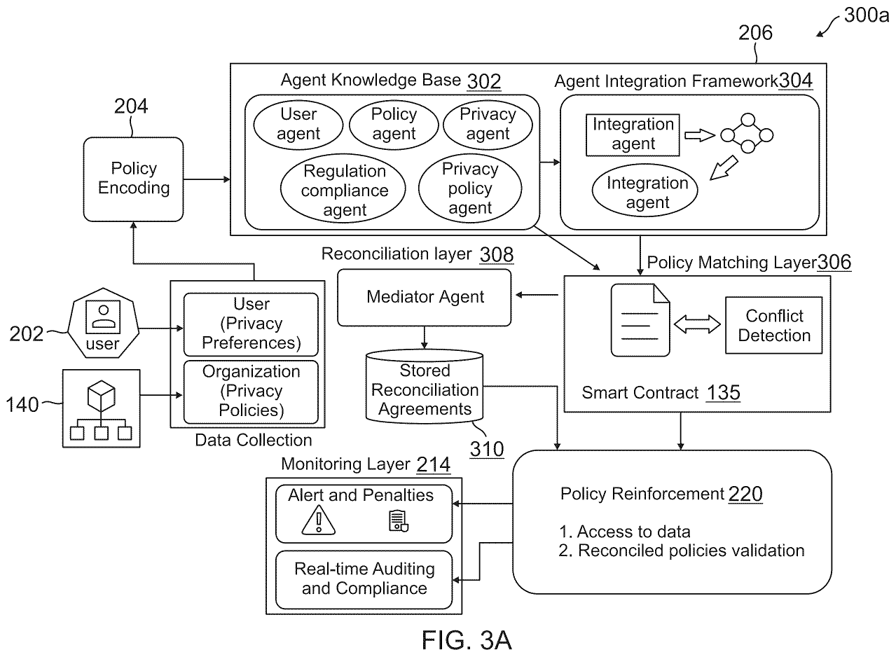

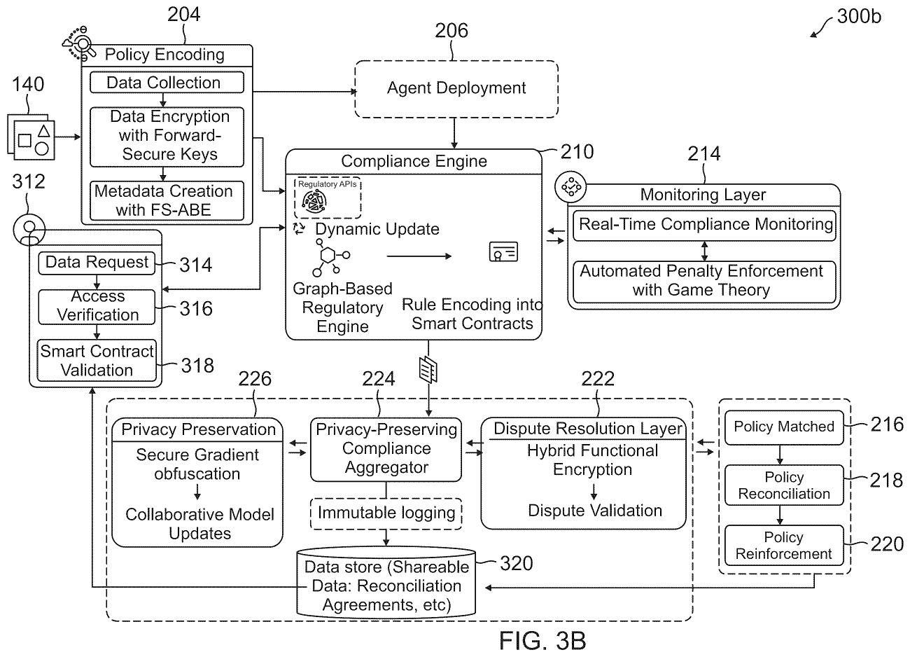

FIGS. 3A and 3B are exemplary diagrams 300a and 300b of system architectures and/or environments where an automated agent may be assigned an encoded data privacy policy that is used to generate and manage a corresponding data privacy policy through a smart contract, according to various embodiments. Diagrams 300a and 300b include components of service provider system 120, as discussed in reference to system 100 of FIG. 1 and diagram 200 of FIG. 2, which may be utilized when deploying smart contracts for policy enforcement and enforcing smart contracts during data requests for privacy protected data. In diagram 300a, data privacy platform 130 is shown in more granular detail when deploying automated agents and reconciling smart contracts, while in diagram 300b, data privacy platform 130 is shown in more granular detail when enforcing a data privacy policy through a smart contract.

In diagram 300a, compliance systems 140 and/or user 202 may provide data privacy policy configurations, such as rules, as well as preferences or selections of options for such rules, to policy encoding process 204, which encodes the corresponding data privacy policy into computer code readable and executable by a processor of service provider system 120 or other service provider and/or data privacy platform. In this regard, automated agents may be deployed for different data privacy policies and enforcement requirements or objectives. Agents may be created and/or deployed based on an agent knowledge base 302, which may include knowledge bases for different AI systems that may be used for automated agents 133. For example, agent knowledge base 302 may include knowledge bases for ‘User agent’, ‘Policy agent’, ‘Privacy agent’, ‘Regulation compliance agent’, and ‘Privacy policy agent,’ as well as other types 134 of automated agents 133. An agent integration framework 304 may then perform the process of combining the characteristics of the bases from agent knowledge base 302 to generate different “integration agents” or automated agents 133, which may be used for different policy enforcement purposes, such as those associated with different data privacy policies.

A policy matching layer 306 may be used to match policies for smart contracts 135 and determine if any conflicts may occur or arise. If a conflict arises, the agents negotiate terms within predefined parameters in a reconciliation layer 308 via a mediator agent. The mediator agent in reconciliation layer 308 may facilitate communication, coordination, and conflict resolution among agents, acting as an intermediary to ensure effective interaction between agents. Once resolved, a reconciliation agreement may be stored to an encrypted database 310. Policy reinforcement process 220 may provide validation of these reconciled policies and may also provide access to data that is controlled through the smart contract. As such, policy reinforcement process 220 may validate data access requests, which may be logged with any policy updates for auditing and compliance.

Referring now to FIG. 3B, diagram 300b shows an enforcement of a data privacy policy after the deployment of the automated agents and a smart contract, as well as reconciliation of the smart contract with other smart contracts, shown in diagram 300a. A data consumer 312 may request data from service provider system 120 or other service provider that may utilize data privacy platform 130 for data privacy management and policy enforcement. Data consumer 312 may submit a data request 314, where an access verification process 316 may be performed to determine an authorization and/or authentication of the user or system requesting the data. If access is allowed and/or confirmed, a smart contract validation process 318 may be performed by compliance engine 210 to determine if the user/system may access the privacy protected data from a data store 320.

In this regard, compliance engine 210 may correspond to a smart contract-based engine that may be used to execute and/or process directed graphs from smart contracts 135 for policies 132. Smart contracts may include directed graphs including DAGs, or other graph-based representations or flowcharts, of decisions and/or operations for determination of data privacy requirements or protections, including decisions on whether to share data, permit access, delete, store, or perform another action with privacy protected data. In some embodiments, directed acyclic graphs (DAGs) encode regulatory conditions, and nodes represent legal condition checks, smart contract execution flows, and/or policy-specific cryptographic enforcement. These may be dynamically updated via APIs and API calls between systems and/or components, such as compliance system 140 and data privacy platform 130. For example, a regulatory API may trigger compliance logic updates in real-time. Once encoded to a DAG or the like, compliance engine 210 may execute and process these graphs. A monitoring and/or enforcement layer may use compliance engine 210 to verify data usage in real-time, aggregate compliance data without revealing raw data records, and/or provide automated penalty enforcement. Automated penalty enforcement may include using game theory, such as Risk-Based Security Scoring (RBS-SMART), which dynamically assigns compliance scores or Stake-Weighted Security Deposits where penalties may be enforced on non-compliant parties.

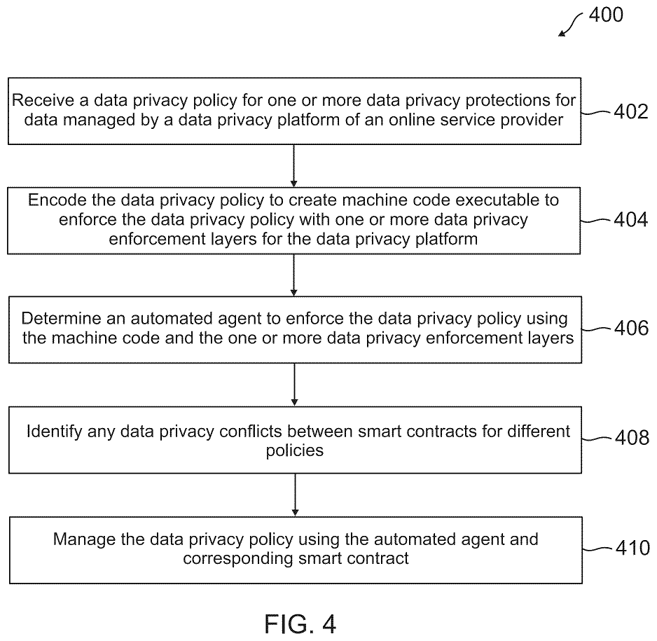

FIG. 4 is a flowchart 400 showing operations or steps for enforcement of data privacy policies through smart contracts with compliance automation for data sharing, according to an embodiment. Note that one or more steps, processes, and methods described herein of flowchart 400 may be omitted, performed in a different sequence, or combined as desired or appropriate.

At step 402 of flowchart 400, a data privacy policy is received for one or more data privacy protections of data managed by a data privacy platform of an online service provider. For example, in system 100 of FIG. 1, client device 110 may be used to engage with service provider system 120 through service applications 122 or other computing services, products, and platforms of service provider system 120, which may require acquisition of data from client device 110 by service provider system 120. This may include privacy data 114, and as such, policies 132 may control storage, deletion, sharing, use, and/or transmission of such data. Policies 132 may be established by compliance systems 140, such as data privacy policies 142 established by an authority, regulator, or other governing body, or may be set by users based on opt-ins/opt-outs, preferences, and the like.

In this regard, policies 132 and other procedures of service provider system 120 may require certain privacy protected data to be managed in certain manners and processes. For example, user data may be required to verify an identity and/or financial data of the user, run risk and/or underwriting for the user, determine authentication credentials and/or authenticate the user, or otherwise collect and/or process data for conditions of data collection, where the conditions correspond to data dependencies for satisfying the data requirements. Policies 132 may be associated with laws, rules, or regulations for certain products and/or computing services including underwriting, data privacy, consumer protection, and the like. Policies 132 may also be associated with risk models and/or fraud systems. Policies 132 may be stored to a repository or other database and accessible for encoding and smart contract enforcement through automated agents 133.

At step 404, the data privacy policy is encoded to create machine code executable to enforce the data privacy policy with one or more data privacy enforcement layers for the data privacy platform. In this regard, data privacy platform 130 may, previously and/or at periodic time intervals, generate and/or update encodings of policies 132 using policy encoder 131. Policy encoder 131 may generate machine-readable and/or machine-executable code or other data in a format that may be processed and executed by an intelligent computer automation, such as a bot, script, program, application, or the like. Policy encoder 131 may synthesize and create the executable code using natural language processing, AI models, and the like to process input text or other information for policies 132 and output code that may be executed to enforce those policies. In some embodiments, the code may correspond to numeric vectors or other mathematical representations of the policies, decisions to be made based on data request for access, sharing, use, deletion, or the like of privacy protected data including privacy data 114. Data privacy policies may have one or more rules, and, as such, encodings of policies 132 may be rule-based and have a corresponding number of encoded rules to be followed based on their numeric vectors. In some embodiments, these rules may be encoded to generate a directed graph or other graph-based representation of the rule(s) of policies 132, which may include DAGs.

At step 406, an automated agent is determined to enforce the data privacy policy using the machine code and the one or more data privacy enforcement layers. Automated agents 133 may correspond to intelligent computer automations, which may process input computer code to make decisions and/or take actions. In this regard, automated agents 133 may be usable to enforce policies 132 using the encodings of policies 132 generated by policy encoder 131. In this regard, automated agents 133 may correspond to AI models, including ML models and/or NNs, that may have a corresponding type of types 134, such as a user agent, a policy agent, a privacy agent, or the like, each of which may be specifically configured and/or trained to handle execution of corresponding data privacy policies and/or tasks associated with data privacy policy enforcement. As such, one of automated agents 133 may be selected based on types 134 that may be matched or correlated to the data privacy policy that has been encoded for enforcement purposes through smart contracts.

At step 408, any data privacy conflicts between smart contracts for different policies are identified. Once a data privacy policy is encoded, automated agents 133 may perform smart contract matching and/or configuring so that a corresponding smart contract may be written to a blockchain that enables enforcement of the encoded data privacy policy. For example, a new smart contract or an existing smart contract of smart contracts 135 for recordation may be created and/or updated to include or reference the encoded data privacy policy. Smart contracts 135 may correspond to directed graphs, such as DAGs or the like based on the numeric vectors for the encoded data privacy policy and therefore may include graph-based representations. Smart contracts 135 may also be rule-based for the rules of policies 132. Engine 136 may be used to execute smart contracts 135 when automated agents 133 identify the conditions for the smart contract as being met (e.g., when a data sharing request for privacy protected data is received), and therefore engine 136 may correspond to a graph-based smart contract execution engine, which may execute directed graphs and the like through graph traversal and other graph-based processing.

However, when smart contracts are generated and/or recorded for encoded data privacy policies, conflicts may arise between two or more smart contracts and their terms for data privacy management, control, or other action taken with respect to privacy protected data. As such, policy conflict resolution 137 on dispute resolution layer 222 may be used to settle disputes by determining the controlling data privacy protection and/or rule for each dispute. Dispute resolution layer 222 may determine the controlling rule based on the rule's importance, priority, age, history, or other factors and information. Dispute resolution layer 222 may then generate a further smart contract that identifies the controlling rule and what action should be taken when the two or more rules from conflicting smart contracts are both triggered or met when enforcing the smart contracts.

At step 410, the data privacy policy is managed using the automated agent and corresponding smart contract. In this regard, smart contracts 135 may be deployed through blockchain recordation and monitoring using automated agents 133. When the rules or other conditions of one of smart contracts 135 is met, such as when privacy protected data is requested, used, identified for erasure or deletion, or the like, engine 136 may execute the directed graph of the corresponding one of smart contracts 135 to determine how to handle the privacy protected data, and/or the action to be taken with the privacy protected data. The data may therefore be shared, protected, deleted, or otherwise managed in accordance with the data privacy policy automatically and in a manner in trusted manner through smart contract requirements. For example, since the smart contracts are recorded to a blockchain, the data privacy policy may be immutable and public, any actions on which the smart contract is based may be further recorded to the blockchain for auditing and policy enforcement. Thus, data privacy platform 130 may provide more secure and efficient management of data privacy in an automated manner without requiring individual oversight and through an open and auditable process, thereby leading to increased trust and faster resolution of data privacy concerns and conflicts.

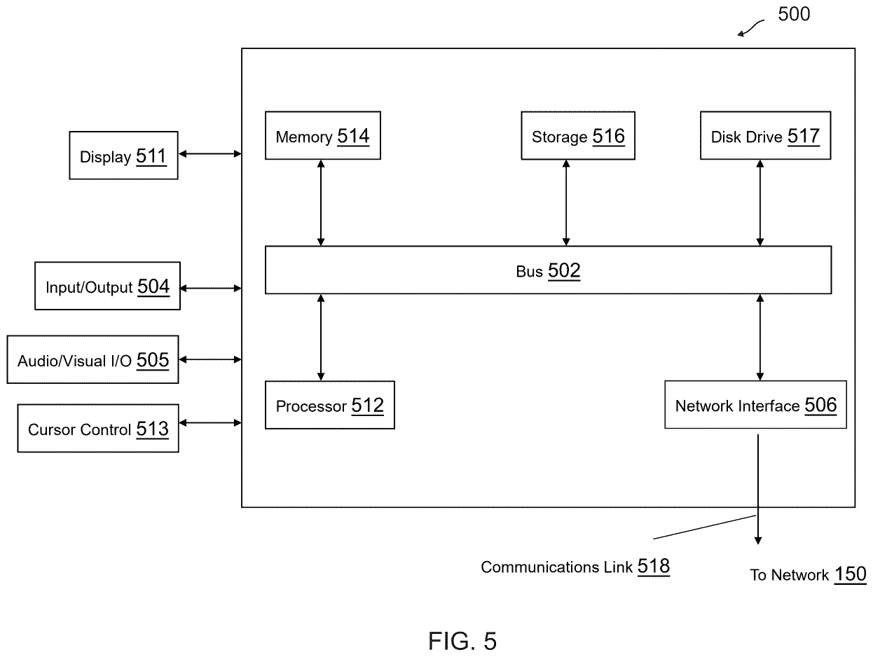

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and,
one or more hardware processors coupled to the non-transitory memory and configured to execute instructions to cause the system to:
access a first data privacy policy associated with a user for an online service provider;
encode the first data privacy policy using a first layer of a plurality of layers associated with providing a first data privacy protection of first data associated with the user for the first data managed by the online service provider;
determine an automated agent for a deployment with the automated agent based on a type of data privacy corresponding to the automated agent and the first data privacy policy;
generate a smart contract executable to cause the first data privacy policy to be enforced for one or more privacy policy decisions associated with at least the first data using the first data privacy policy;
execute the smart contract on a second layer of the plurality of layers configured for policy enforcement of different data privacy policies of the online service provider or the user; and
reconcile the first data privacy policy with the different data privacy policies enforced by one or more additional automated agents on the second layer.

2. The system of claim 1, wherein the automated agent is a policy integration agent of a plurality of policy integration agents, and wherein the automated agent monitors the first data privacy policy with the different data privacy policies that have been encoded and are enforced by the one or more additional automated agents.

3. The system of claim 1, wherein, after encoding the first data privacy policy, the instructions are further executed to cause the system to:
encrypt the first data privacy policy in a machine-readable format, wherein the first data privacy policy once encrypted and encoded represents the first data privacy policy in the machine-readable format that is decryptable by one or more of the automated agents.

4. The system of claim 3, wherein the computer code, when executed, controls access to and sharing of the first data in accordance with the first data privacy policy.

5. The system of claim 1, wherein the instructions are further executed to cause the system to:
review the first data privacy policy and one or more policy requirements of the online service provider; and
determine whether the first data privacy policy complies with the one or more privacy requirements.

6. The system of claim 1, wherein the smart contract comprises a graph-based executable contract configured to provide a graph traversal of directed graphs corresponding to the first data privacy policy for the one or more privacy policy decisions.

7. The system of claim 6, further comprising a smart contract-based engine configured to execute smart contracts for the one or more privacy policy decisions, and wherein the smart contract-based engine is further configured to process directed graphs and perform the graph traversal of the directed graph when executing the smart contracts for enforcing the first data privacy policy and determining the one or more privacy policy decisions.

8. The system of claim 1, wherein the user comprises one of an individual user or a representative user of an entity that utilizes the online service provider for one or more computing services.

9. A method comprising:
accessing a privacy policy for an online service provider that manages privacy protected data on behalf of users of the online service provider, wherein the privacy policy comprises a plurality of data privacy rules that provide at least one data privacy protection to the users:
encoding each of the plurality of data privacy rules using a first layer of a plurality of layers associated with providing the at least one data privacy protection for the privacy protected data;
determining a plurality of rule encodings based on the encoding each of the plurality of data privacy rules;
deploying, via a plurality of automated agents, the plurality of rule encodings with a plurality of smart contracts, wherein the plurality of smart contracts are executable to enforce the plurality of data privacy rules through one or more second layers of the plurality of layers;
generating the plurality of smart contracts executable to enforce the plurality of data privacy rules for privacy policy decisions and usages of the privacy protected data by the online service provider;
deploying the plurality of automated agents with a compliance engine that enables an execution of the plurality of smart contracts on the one or more second layers configured to automate compliance disputes with at least one of the plurality of data privacy rules or the at least one data privacy protection; and
resolving one or more disputes between different ones of the plurality of data privacy rules that are detected by the plurality of automated agents on the one or more second layers.

10. The method of claim 9, wherein the determining the plurality of rule encodings comprises:
encrypting the plurality of rule encodings using a forward-secure key technique; and
providing the encrypted plurality of rule encodings to the plurality of automated agents.

11. The method of claim 10, wherein the plurality of rule encodings are encrypted in a machine-readable format executable by the plurality of automated agents.

12. The method of claim 9, wherein each of the plurality of smart contracts controls access to a corresponding portion of the privacy protected data stored by the online service provider for the users.

13. The method of claim 9, wherein the determining the plurality of rule encodings includes generating at least one of the plurality of rule encodings that restricts the privacy protected data from being used in a record on a blockchain associated with one or more of the plurality of smart contracts.

14. The method of claim 9, wherein each of the plurality of rule encodings comprises machine-readable code generated from a corresponding one of the plurality of data privacy rules.

15. The method of claim 14, wherein the machine-readable code comprises encrypted numeric vectors.

16. The method of claim 9, wherein each of the plurality of automated agents has a corresponding knowledge base corresponding to a type of data privacy enforced by each of the plurality of automated agents.

17. A non-transitory machine-readable medium having stored thereon machine-readable instructions executable to cause a machine to perform operations comprising:
assigning a data privacy rule to an automated agent for enforcement using a smart contract, wherein the data privacy rule is encoded from a data privacy policy associated with a service provider;
generating the smart contract executable to enforce the data privacy rule for one or more allowable uses of privacy protected data by the service provider;
deploying the automated agent with a compliance engine that enables the compliance engine to execute at least the smart contract in response to receiving a request for a use of the privacy protected data;
receiving the request for the use of the privacy protected data from a requester;
determining that the request complies with the one or more allowable uses based on the data privacy rule; and
permitting the requester to access the privacy protected data in compliance with the data privacy rule.

18. The non-transitory machine-readable medium of claim 17, wherein the operations further comprise:
generating a record of the request and the requester being permitted access to the privacy protected data.

19. The non-transitory machine-readable medium of claim 18, wherein the record is generated independent of the privacy protected data being included in the record.

20. The non-transitory machine-readable medium of claim 17, wherein the operations further comprise:
resolving a dispute between the data privacy rule and another data privacy rule detected by the automated agent.
